(19) United States
(12) Patent Application Publication
(10) Pub. No.: US 2012/0160656 A1
(43) Pub. Date: Jun. 28, 2012

(54) KEYBOARD WITH ECCENTRICAL TRIGGERING MECHANISM

(76) Inventor: Ling-Hsi Chao, Taoyuan (TW)

(21) Appl. No.: 13/337,294

(22) Filed: Dec. 27, 2011

(30) Foreign Application Priority Data
Dec. 27, 2010 (TW) 099225124

(51) Int. Cl. H01H 13/14

(52) U.S. Cl. 200/520

(57) ABSTRACT

In a cantilever keycap of a keyboard, an elastic piece, which is used for providing the click sense and a restoring force for the keycap, is disposed under an extension section, or the intersection of the extension section and a press section, and the elastic piece locates farther than the press section from the pivot of the keycap. The distance between a contact point, which presses the elastic piece, and the pivot is larger than that between the press section and the pivot. Hence, a shorter stroke of a user pressing the press section produces a longer stroke of the keycap that presses and deforms the elastic piece, which effectively adds up the click sense.

### BACKGROUND OF THE INVENTION

1. Field of the Invention

The invention relates to a keyboard, and more particularly, to an eccentrically triggering keyboard wherein the elastic piece is disposed not directly under the keycap.

2. Description of the Prior Art

Keyboards are necessary for inputting text, symbols, or numbers in the common computer using environment. Generally, a keyswitch module in the prior art mainly includes a bottom board, a keycap, and a lifting device connecting between the bottom board and the keycap. Since the keycap requires being moving up and down steadily so as to properly press and trigger an electrical switch, rubber domes are commonly adapted as the lifting device and disposed right under the keycaps. When the keycap is forced downward, the rubber dome is pressed and deformed, thereby providing elastic recovery force upward. Most rubber domes are designed to go through deformation for some extent before proper sense of click may be generated, but as long as the miniaturized trend for keyboards and keycaps substantially limits the moving stroke of the keycaps, design of the rubber domes are much harder in order to have effective sense of click given a limited moving stroke of the keycap.

On the other hand, more and more luminescent keyboards are released to have various lighting or indicating functions by using transparent or translucent keycaps. However, the lifting devices, or the rubber domes, of the prior art lie partially or totally under the keycaps and inevitably block the lights from below the keycaps, which reduces overall performance of the luminescent keyboards.

### SUMMARY OF THE INVENTION

An embodiment of the invention provides a keyboard including a circuit board and a keyswitch module. The circuit board includes a switch and the keyswitch module is disposed on the circuit board. The keyswitch module includes a seat, a keycap, and an elastic piece. The keycap is connected to the seat via a pivot. The keycap includes a press section and an extension section. The elastic piece is disposed between the extension section of the keycap and the switch of the circuit board. The elastic piece is deformed by the keycap to trigger the switch.

Another embodiment of the invention provides a keyboard including a circuit board and a keyswitch module. The circuit board includes a switch and the keyswitch module is disposed on the circuit board. The keyswitch module includes a seat, a keycap, and an elastic piece. The keycap is connected to the seat via a pivot. The keycap includes a press section and an extension section. The elastic piece is disposed between the keycap and the switch of the circuit board. The elastic piece is disposed under both the press section and the extension section and is deformed by the keycap to trigger the switch.

The keyboard in the invention disposes the elastic piece at an eccentric position with respect to the keycap that has larger arm of force so as to acquire clear sense of click in an easier way, which makes design of the elastic piece easier and also provides fine performance to an luminescent keyboard given the eccentric configuration of the elastic piece.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a keyboard according to an embodiment of the invention.

FIG. 2 is an illustration of a keyswitch module according to an embodiment of the keyboard.

FIG. 3 is an illustration showing side sectional view of the keyswitch module in FIG. 2.

FIG. 4 is an illustration of a keyswitch module according to another embodiment of the keyboard.

FIG. 5 is an illustration showing side sectional view of the keyswitch module in FIG. 4.

### DETAILED DESCRIPTION

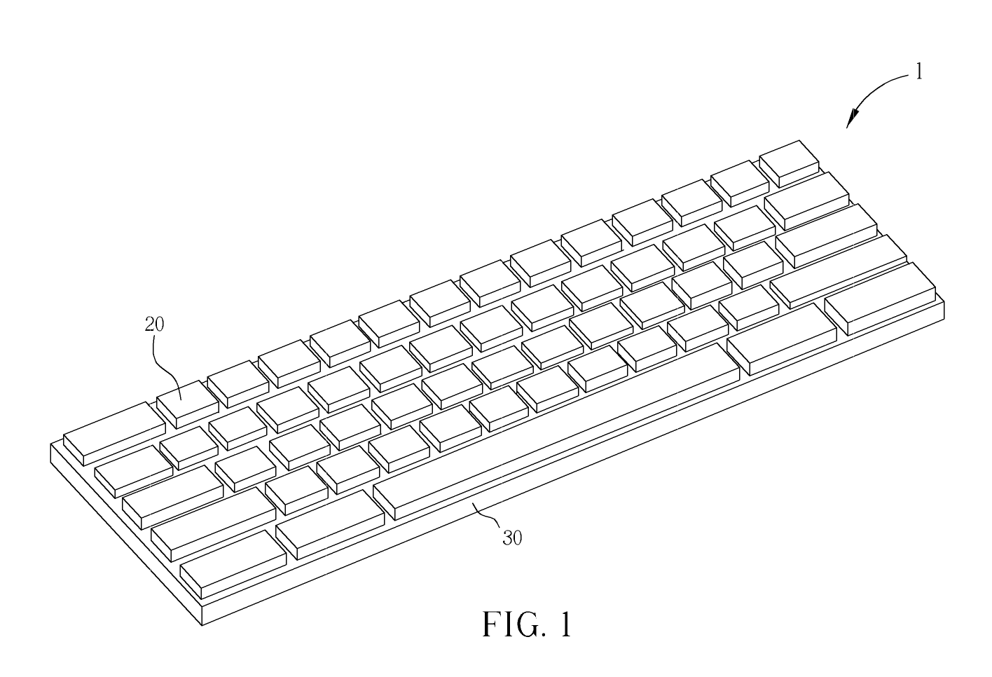

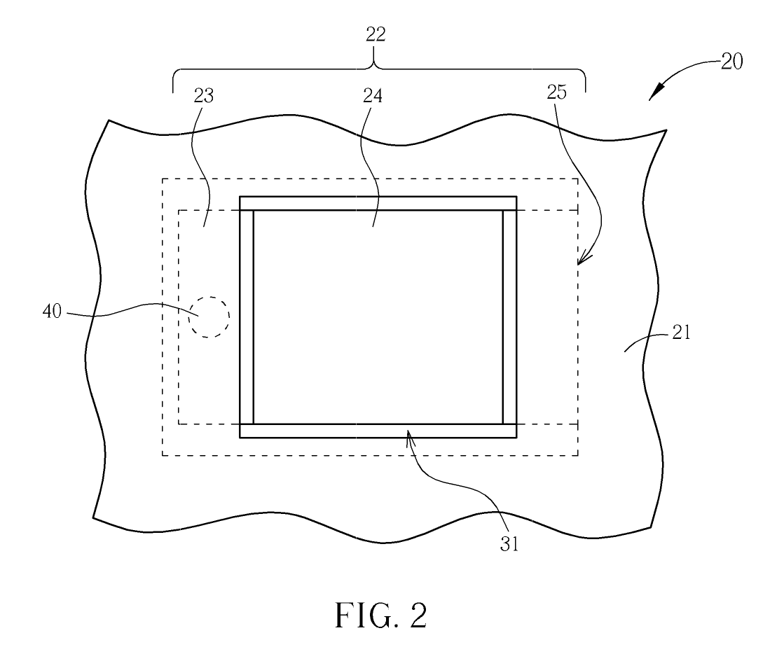

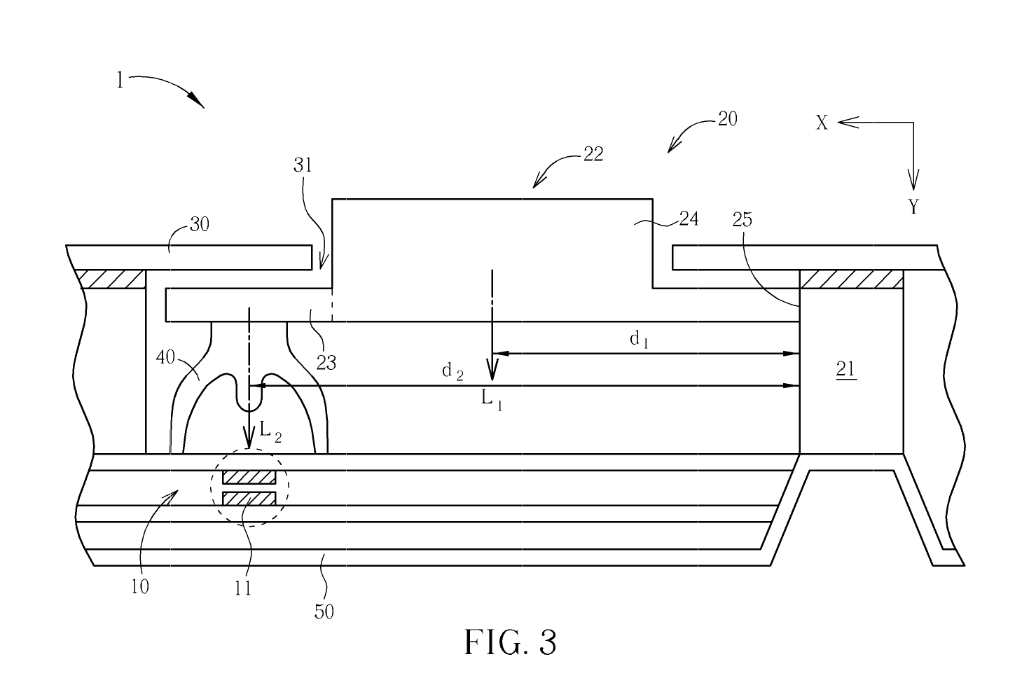

Please refer to FIG. 1, which is an illustration of an eccentrically triggering keyboard 1 according to an embodiment of the invention. The keyboard 1 includes a cover 30 and a plurality of keyswitch modules 20. Please refer to FIG. 2 and FIG. 3. FIG. 2 is an illustration of one of the keyswitch modules 20 according to an embodiment of the keyboard 1, and FIG. 3 is an illustration showing side sectional view of the keyswitch module 20 in FIG. 2. As illustrated in the figures, the keyboard 1 includes a bottom board 50 as a bottom structure, and a circuit board 10 disposed on the bottom board 50. The keyswitch module 20 is disposed on the circuit board 10, whereas the cover 30 is disposed on the keyswitch module 20. In the embodiments of the application, the circuit board 10 is preferably a thin-film circuit board, which has switches 11 capable of be triggered by compression and corresponding to each keyswitch module 20. Each keyswitch module 20 includes a seat 21, a keycap 22, and an elastic piece 40. The seat 21 and the keycap 22 may be either formed monolithically or manufactured as two separate components.

A pivot 25 exists between the keycap 22 and the seat 21 that connects the keycap 22 to the seat 21 such that the keycap 22 is cantilevered. The keycap 22 has a protruding press section 24 and an extension section 23, which extends toward under the cover 30. The cover 30 of the keyboard 1 has a plurality of openings 31, each corresponding to the keycap 22 of each of the plurality of keyswitch modules 20. Hence, as all the components of the keyboard 1 are assembled together, each press section 24 of the keycap 22 is in the state of extending out of a corresponding opening 31 of the cover 30 for allowing a user to press downward the keycap 22 along direction y. Meanwhile, since the extension section 23 of the keycap 22 is located under the cover 30, the extension section 23 may be well withstood by the horizontally oriented cover 30 as the keycap 22 is pressed to have up-and-down movement, or vertical movement. The cover 30 then functions to restrain the keycap 22 from moving over the horizontal level.

The cantilever type keycap 22 in the keyswitch module 20 follows geometrical rules in space. Please refer to FIG. 3. The extension section 23 of the keycap 22 is located farther than the press section 24 from the pivot 25 along direction x, which in other words, the distance d₂ between the extension section 23 and the pivot 25 is larger than the distance d₁ between the press section 24 and the pivot 25. Furthermore, the elastic piece 40, preferably a rubber dome, of each keyswitch module 20 in the keyboard 1 is disposed under the extension section 23, i.e., between the extension section 23 and the circuit board 10, while the switch 11 of the circuit board 10 is located under the elastic piece 40 for being triggered by the elastic piece 40. When the keycap 22 is pressed by the user to move downward along direction y, the elastic piece 40 is pressed and deformed by the keycap 22 to trigger the switch 11 beneath that will generate corresponding signal.

Please note that for the embodiment in FIG. 2 and FIG. 3, the elastic piece 40 is located right under the extension section 23. The elastic piece 40 is totally not located under the press section 24 of the keycap 22. Geometrically, as the press section 24 of the keycap 22 is forced to move downward along direction y for a first stroke L₁, with respect to the seat 21, the extension section 23 also moves downward along direction y for a second stroke L₂, and the second stroke L₂ is larger than the first stroke L₁ (since both the press section 24 and the extension section 23 move in a relatively small distance, the movement of both sections 24, 23 may be regarded as vertical movement for simplicity). In such way, a shorter press toward the press section 24 of each keycap 22 produces longer movement of the extension section 23 that will have effective pressing and deforming scale toward the elastic piece 40. Users can experience clear sense of click from the elastic piece 40. Additionally, as the elastic piece 40 does not locate under the press section 24, an unblocked space is provided between the press section 24 of the keycap 22 and the circuit board 10, which also provides full effect as for a luminescent keyboard given transparent or translucent keycaps 22.

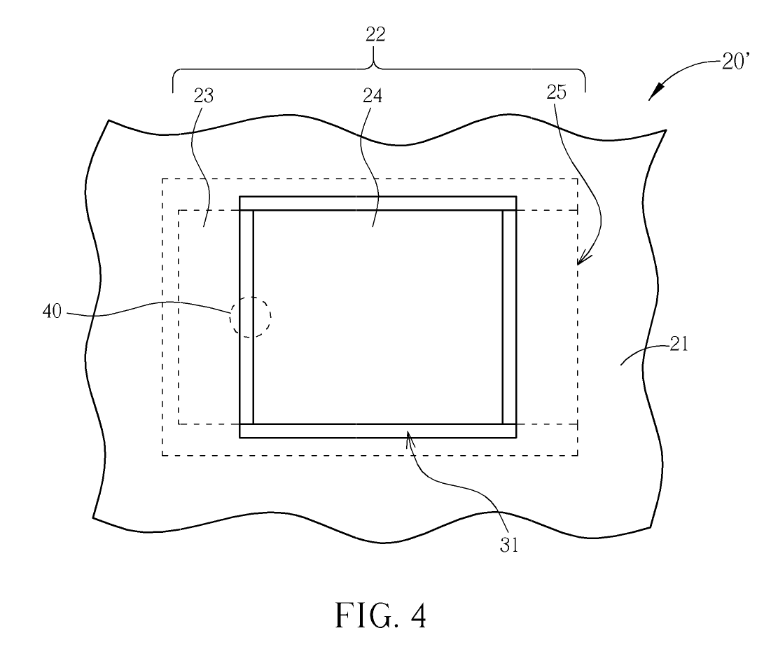

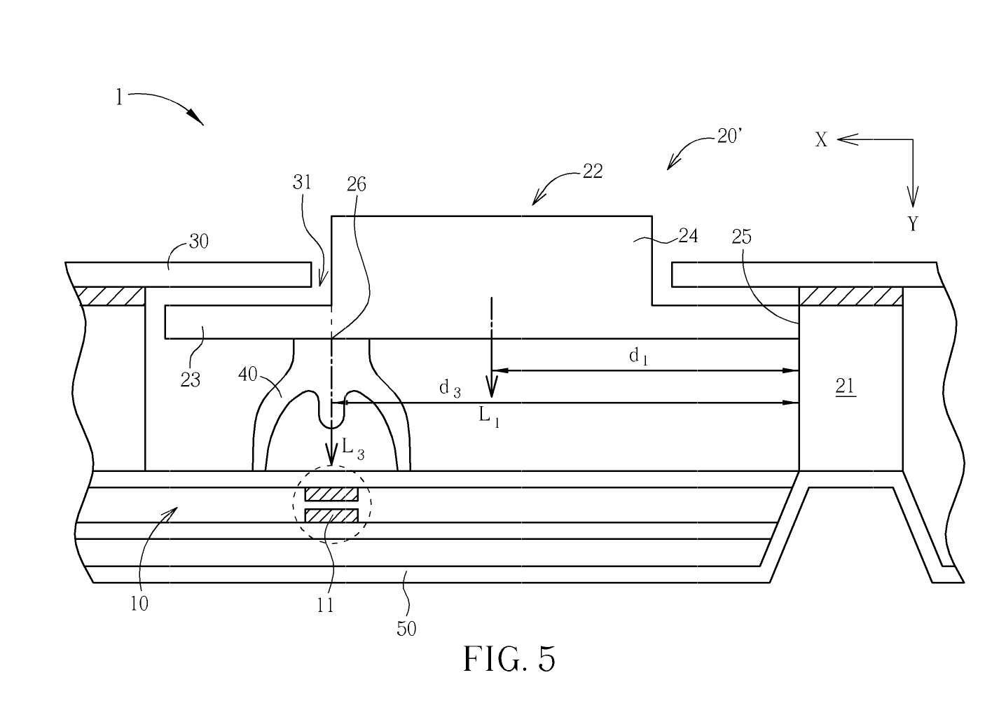

Please refer to FIG. 4 and FIG. 5. FIG. 4 is an illustration of one of the keyswitch modules 20′ according to an embodiment of the keyboard 1, and FIG. 5 is an illustration showing side sectional view of the keyswitch module 20′ in FIG. 4. The elastic piece 40 of the keyswitch module 20′ may also be either located partially under the press section 24 or under both the extension section 23 and the press section 24 as shown in FIG. 5, where a contact point 26 of the keycap 22 connects the elastic piece 40. Similar with the former embodiment, the distance d₃ between the contact point 26 and the pivot 25 is larger than the distance d₁ between the press section 24 and the pivot 25, and the elastic piece 40 is disposed under the contact point 26, i.e., between the keycap 22 and the circuit board 10, while the switch 11 of the circuit board 10 is located under the elastic piece 40 for being triggered by the elastic piece 40.

For the embodiment in FIG. 4 and FIG. 5, the elastic piece 40 has the feature that locates ‘not’ totally under the press section 24, which also only needs users to provide a shorter press toward the press section 24 of each keycap 22 while still produces effective pressing and deforming scale toward the elastic piece 40. Users can experience clear sense of click from the elastic piece 40.

In the cantilever keycap of the keyboard disclosed in the invention, the elastic piece, which is used for providing click sense and the restoring force for the keycap, is disposed under the extension section, or the intersection of the extension section and the press section of the keycap, such that the elastic piece is located farther than the press section from the pivot of the keycap. The distance between the contact point, which presses the elastic piece, and the pivot is larger than that between the press section and the pivot. Hence, a shorter stroke of a user pressing the press section produces a longer stroke of the keycap that presses and deforms the elastic piece, which effectively adds up the click sense.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard, comprising:
a circuit board comprising a switch; and
a keyswitch module disposed on the circuit board, the keyswitch module comprising:
a seat;
a keycap connected to the seat via a pivot, the keycap comprising a press section and an extension section; and
an elastic piece disposed between the extension section of the keycap and the switch of the circuit board, the elastic piece deformed by the keycap to trigger the switch.

2. The keyboard of claim 1, wherein when the press section of the keycap is forced to move for a first stroke along a first direction relative to the seat, the extension section moves for a second stroke along the first direction to press and deform the elastic piece, and the second stroke is larger than the first stroke.

3. The keyboard of claim 1, further comprising a cover disposed on the keyswitch module, the press section extending out of an opening of the cover and the cover withstanding the extension section for restraining movement of the keycap.

4. The keyboard of claim 1, wherein the elastic piece is a rubber dome.

5. The keyboard of claim 1, wherein the circuit board is a thin-film circuit board.

6. The keyboard of claim 1, wherein the distance between the extension section and the pivot is larger than the distance between the press section and the pivot.

7. A keyboard, comprising:
a circuit board comprising a switch; and
a keyswitch module disposed on the circuit board, the keyswitch module comprising:
a seat;
a keycap connected to the seat via a pivot, the keycap comprising a press section and an extension section; and
an elastic piece disposed between the keycap and the switch of the circuit board, the elastic piece disposed under both the press section and the extension section and deformed by the keycap to trigger the switch.

8. The keyboard of claim 7, wherein when the press section of the keycap is forced to move for a first stroke along a first direction relative to the seat, a contact point of the keycap with the elastic piece moves for a second stroke along the first direction to press and deform the elastic piece, and the second stroke is larger than the first stroke.

9. The keyboard of claim 7, further comprising a cover disposed on the keyswitch module, the press section extending out of an opening of the cover and the cover withstanding the extension section for restraining movement of the keycap.

10. The keyboard of claim 7, wherein the elastic piece is a rubber dome.

11. The keyboard of claim 7, wherein the circuit board is a thin-film circuit board.

12. The keyboard of claim 7, wherein the distance between the extension section and the pivot is larger than the distance between the press section and the pivot.
